(19) United States
(12) Patent Application Publication
(10) Pub. No.: US 2010/0210458 A1
(43) Pub. Date: Aug. 19, 2010

(54) BIOMICROMOLECULE-SEPARATING, MONOLITHIC SILICA COLUMN AND ITS PRODUCTION PROCESS, AND SEPARATION METHOD OF BIOMICROMOLECULES

(75) Inventors: Tomoko Katsuhara, Kanagawa (JP); Masahiro Matsumoto, Kanagawa (JP); Kazuhiko Ishihara, Tokyo (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/702,046

(22) Filed: Feb. 8, 2010

(30) Foreign Application Priority Data
Feb. 16, 2009 (JP) P2009-032548

(51) Int. Cl. B01J 20/26

(52) U.S. Cl. 502/402

(57) ABSTRACT

A biomicromolecule-separating, monolithic silica column having a silica matrix and pores formed in the silica matrix, the silica matrix and pores have been modified at surfaces thereof with a polymer, which is obtainable by polymerization of a monomer composition including a phosphorylcholine-analogous-group-containing monomer represented by the following formula (1):

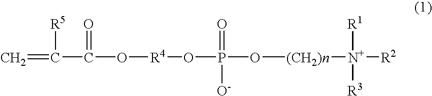

R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, such that the surface-modified pores are provided with a pore size comparable to a molecular size of biomicromolecules to be separated.

### CROSS REFERENCES TO RELATED APPLICATIONS

The present application claims priority to Japanese Priority Patent Application JP 2009-032548 filed in the Japan Patent Office on Feb. 16, 2009, the entire content of which is hereby incorporated by reference

### BACKGROUND

The present disclosure relates to a biomicromolecule-separating, monolithic silica column and its production process, and a separation method of biomicromolecules.

For the analysis of biomicromolecules such as a neurotransmitter and hormone, high-performance liquid chromatography (HPLC) making use of a reversed-phase column as a separation column is widely employed. In a biosample such as plasma, serum, saliva or urine, biomicromolecules exist as a mixture with proteins, which have higher molecular weights than the biomicromolecules, and a great deal of salts. Upon performing an HPLC analysis of biomicromolecules in a biosample, a pretreatment operation is conducted to eliminate proteins and salts from the biosample before charging the biosample into a separation column. If the biosample were charged directly into the separation column without conducting the pretreatment operation, the proteins in the biosample would be adsorbed on a packing material in the separation column to result in an increased column pressure or deteriorated column performance so that the biomicromolecules would not be efficiently separated and the analytical sensitivity would be lowered.

As separation columns capable of bringing about high separation capacity in HPLC analyses, monolithic silica columns have been finding utility in recent years as replacements for existing columns packed with microparticles (see Japanese Patent Laid-open No. 2003-075420 (hereinafter referred to as Patent Document 1)). Different from existing columns packed with silica particles, monolithic silica columns have a structure that a silica matrix in the form of a three-dimensional network and its voids, which are also called “throughholes,” “macropores,” “throughpores” or the like, are integrated together. In addition, fine pores which are also called “mesopores” also exist in the silica matrix of a monolithic silica column. The pore sizes of throughpores can be independently controlled in a range of from several to several hundreds micrometers, while the pore sizes of mesopores can be independently controlled in a range of from several to several tens nanometers. By the molecular sieving effect available from the existence of these pores, a monolithic silica column separates biomicromolecules from proteins and salts.

As separating materials for the isolation of specific components originated from living bodies or the like, separating materials having phosphorylcholine analogous groups on their surfaces have been being developed recently (see the above-described Japanese Patent Laid-open No. 2002-98676 (hereinafter referred to as Patent Document 2)). Phosphorylcholine-analogous-group-containing polymers have been found to have properties such as blood compatibility, complement activity and non-absorptivity for biomaterials owing to a phospholipid analogous structure derived from biomembranes. With respect to phosphorylcholine-analogous-group-containing polymers containing, active developments of biologically-relevant materials, which make use of these functions, have been under way in recent years. With the separating material disclosed in Patent Document 2, it is described possible to separate one of “cells,” “proteins” and “neurotransmitters” from a body-derived component by controlling the percentage or the like of phosphorylcholine analogous groups existing on a surface of the separating material (see claim 5 of Patent Document 2). It is, however, to be noted that no discussion is made concerning the separation of only a particular substance (biomicromolecules) with the separating material, for example, from “neurotransmitters.”

### SUMMARY

To permit a high-accuracy analysis of biomicromolecules such as a neurotransmitter or hormone in a biosample, there is an outstanding desire for a separation column that can prevent adsorption of proteins on the column, can selectively separate target biomicromolecules and can recover them with a high yield.

It is desirable to provide a separation column that can efficiently retain biomicromolecules, especially biomicromolecules to be analyzed, in the column while preventing adsorption of proteins on the column.

In one embodiment, there is hence provided a biomicromolecule-separating, monolithic silica column having a silica matrix and pores formed in the silica matrix, the silica matrix and pores have been modified at surfaces thereof with a polymer, which is obtainable by polymerization of a monomer composition including a phosphorylcholine-analogous-group-containing monomer represented by the following formula (1):

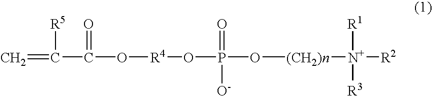

R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, such that the surface-modified pores are provided with a pore size comparable to a molecular size of biomicromolecules to be separated.

With the biomicromolecule-separating, monolithic silica column, it is possible to prevent adsorption of proteins on the column owing to high hydrophilicity of the phosphorylcholine-analogous-group containing polymer with which the silica matrix and the pores formed in the silica matrix are modified at their surfaces. Further, the surface-modified pores have a pore size controlled to be comparable to the molecular size of biomicromolecules to be separated, and therefore, the target biomicromolecules can be selectively allowed to enter the pores and can be retained there.

In another embodiment, there is also provided a method for separating biomicromolecules, which includes using the biomicromolecule-separating, monolithic silica column.

In a further embodiment, there is also provided a process for producing a biomicromolecule-separating, monolithic silica column, which includes the steps of providing a monolithic silica column having a silica matrix and pores formed in the silica matrix, the pores having a pore size predetermined in accordance with biomicromolecules to be separated, providing a polymer obtainable by polymerization of a monomer composition, which includes a phosphorylcholine-analogous-group-containing monomer represented by the following formula (1):

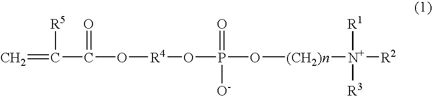

R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, to a predetermined molecular weight in accordance with a molecular size of the biomicromolecules to be separated, and modifying the silica matrix and pores of the monolithic silica column at surfaces thereof with the polymer.

It is to be noted that the term “pore size” of pores as used herein means the diameters of the pores in a state that they have been modified with the phosphorylcholine-analogous-group-containing polymer. It is also to be noted that the diameters of pores in a state that they have not been modified with the phosphorylcholine-analogous-group-containing polymer will be referred to simply as “pore diameter.”

The present embodiment provides a separation column which can efficiently retain biomicromolecules, especially biomicromolecules to be analyzed in the column, while preventing adsorption of proteins on the column.

Additional features and advantages are described herein, and will be apparent from the following Detailed Description and the figures.

### BRIEF DESCRIPTION OF THE FIGURES

FIG. 1 shows an HPLC chromatogram obtained by conducting separation and detection of cortisol from a saliva solution with a biomicromolecule-separating, monolithic silica column according to the present embodiment.

### DETAILED DESCRIPTION

With reference to the accompanying drawing, a description will hereinafter be made about preferred embodiments. The description will be made in the following order.

1. Biomicromolecule-separating, monolithic silica column and its production process

(1) Monolithic silica column

(2) Surface hydrophilization treatment with MPC polymer

(3) Optimization for biomicromolecules to be analyzed

2. Separation method of biomicromolecules

(1) Biomicromolecules to be separated

(2) Solution to be separated

(3) Separation procedure

1. Biomicromolecule-Separating, Monolithic Silica Column and its Production Process

(1) Monolithic Silica Column

For separating biomicromolecules, the present embodiment makes use of a monolithic silica column having a structure in which mesopores are formed in a three-dimensional network silica matrix with throughpores formed therein. As the monolithic silica column, a commercially-available column or a column obtained by the known process disclosed in the above-described Patent Document 1 or the like can be used. In general, a rod-type, monolithic silica column for HPLC is formed from an organosilane. A silica matrix structure is formed, for example, as a result of freezing of a transitional ordered structure, which has been formed by phase separation based on spinodal decomposition, through a hydrolysis-polycondensation reaction of an organosilane in an aqueous acetic acid solution of an alkoxysilane and polyethylene glycol (PEG). The hydrolysis-polycondensation reaction is accompanied by sol-gel transition. On the other hand, mesopores are formed by conducting treatment with ammonia after the formation of the silica matrix.

Throughpores in monolithic silica are formed by sol-gel transition based on spinodal decomposition. As mesopores are formed by treatment with ammonia, the pore sizes of throughpores and mesopores can be independently controlled. Described specifically, the throughpore size and mesopore size can be controlled in a range of from several to several hundreds micrometers and a range of from several to several tens nanometers, respectively, by changing the rate of phase separation, the freezing rate by polycondensation, the intensity of the treatment with ammonia, and so on. In the present embodiment, a monolithic silica column with mesopores formed in a silica matrix and having a pore size predetermined in accordance with the molecular size of biomicromolecules to be separated is provided and used as will be mentioned subsequently herein.

(2) Surface Hydrophilization Treatment with MPC Polymer

To prevent proteins in a sample from being adsorbed on the monolithic silica, hydrophilicity is imparted to the monolithic silica column at a surface of its three-dimensional network silica matrix (surfaces of throughpores as voids in the matrix) and surfaces of its pores formed in the silica matrix (surfaces of mesopores).

The impartation of hydrophilicity can be conducted by chemically modifying the surfaces of the monolithic silica with a phosphorylcholine-analogous-group-containing polymer. The phosphorylcholine-analogous-group-containing polymer shows high adsorption-preventing effects to proteins owing to the hydrophilicity attributable to its phospholipid analogous structure derived from biomembranes.

The phosphorylcholine-analogous-group-containing polymer can be obtained by polymerizing a monomer composition which contains a phosphorylcholine-analogous-group-containing monomer represented by the following formula (1):

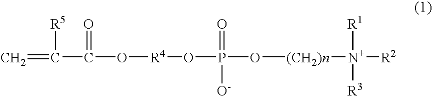

R¹, R² and R³ are the same or different and each represent a hydrogen atom, C₁₋₆ alkyl group or C₁₋₆ hydroxyalkyl group. Examples of the C₁₋₆ alkyl group include methyl, ethyl, propyl, butyl, pentyl, hexyl, cyclohexyl, phenyl, and the like. Examples of the C₁₋₆ hydroxyalkyl group include hydroxymethyl, 2-hydroxyethyl, 3-hydroxypropyl, 4-hydroxybutyl, 5-hydroxypentyl, 6-hydroxyhexyl, and the like. Further, R⁴ represents a C₁₋₆ alkylene group, R⁵ represents a hydrogen atom or methyl group, and n stands for an integer of from 1 to 4.

Illustrative of the phosphorylcholine-analogous-group-containing monomer represented by the formula (1) are 2-((meta)acryloyloxy)ethyl-2′-(trimethylammonio)ethyl phosphate, 3-((meta)acryloyloxy)propyl-2′-(trimethylammonio)ethyl phosphate, 4-((meta)acryloyloxy)butyl-2′-(trimethylammonio)ethyl phosphate, 5-((meta)acryloyloxy)pentyl-2′-(trimethylammonio)ethyl phosphate, 6-((meta)acryloyloxy)hexyl-2′-(trimethylammonio)ethyl phosphate, 2-((meta)acryloyloxy)ethyl-2′-(triethylammonio)ethyl phosphate, 2-((meta)acryloyloxy)ethyl-2′-(tripropylammonio)ethyl phosphate, 2-((meta)acryloyloxy)ethyl-2′-(tributylammonio)ethyl phosphate, 2-((meta)acryloyloxy)ethyl-2′-(tricyclohexylammonio)ethyl phosphate, 2-((meta)acryloyloxy)ethyl-2′-(triphenylammonio)ethyl phosphate, 2-((meta)acryloyloxy)propyl-2′-(trimethylammonio)ethyl phosphate, 2-((meta)acryloyloxy)butyl-2′-(trimethylammonio)ethyl phosphate, 2-((meta)acryloyloxy)pentyl-2′-(trimethylammonio)ethyl phosphate, 2-((meta)acryloyloxy)hexyl-2′-(trimethylammonio)ethyl phosphate, and the like. Among these, 2-((meta)acryloyloxy)ethyl-2′-(trimethylammonio)ethyl phosphate (also called “2-methacryloyloxyethylphosphorylcholine”; hereinafter abbreviated as “MPC”) is preferred from the standpoint of availability.

These phosphorylcholine-analogous-group-containing monomers can be produced by a known process. For example, they can be produced following the known process disclosed in Japanese Patent Laid-open No. Sho 54-63025 (hereinafter referred to as Patent Document 3), Japanese Patent Laid-open No. Sho 58-154591 or the like. As a specific process, a cyclic phosphorus compound and 2-hydroxyethyl (meth)acrylate are reacted to each other in the presence of a dehydrohalogenation agent, and trimethylamine is then reacted to cause ring-opening so that a target monomer is obtained. With respect to MPC, its production process is described in Patent Document 3.

The phosphorylcholine-analogous-group-containing polymer is obtained by polymerizing a monomer composition composed of the above-described phosphorylcholine-analogous-group-containing monomer, and optionally, another monomer, for example, a hydrophobic or hydrophilic monomer mixed as needed. As another monomer, the following monomers can be exemplified.

Examples of the hydrophilic monomer include linear or branched alkyl (meth)acrylates such as methyl (meth)acrylate, ethyl (meth)acrylate, butyl (meth)acrylate, 2-ethylhexyl (meth)acrylate, lauryl (meth)acrylate, and stearyl (meth)acrylate; cycloalkyl (meth)acrylates such as cyclohexyl (meth)acrylate; aromatic (meth)acrylates such as benzyl (meth)acrylate and phenoxyethyl (meth)acrylate; hydrophobic polyalkylene glycol (meth)acrylates such as polypropylene glycol (meth)acrylate; styrenic monomers such as styrene, methylstyrene and chloromethylstyrene; vinyl ether monomers such as methyl vinyl ether and butyl vinyl ether; vinyl ester monomers such as vinyl acetate and vinyl propionate; and the like. They can be used either singly or in combination.

Examples of the hydrophilic monomer include monomers and the like, each of which contains a hydrophilic group selected from the group consisting of hydroxyl, carboxyl, sulfonic, amido, amino, dialkylamino, trialkylamine salt, trialkylphosphonium salt and polyoxyethylene groups. Specific examples include hydroxyl-containing (meth)acrylates such as 2-hydroxyethyl (meth)acrylate, 2-hydroxybutyl (meth)acrylate and 4-hydroxybutyl (meth)acrylate; carboxylic acids such as acrylic acid and methacrylic acid; ionic-group-containing monomers such as styrenesulfonic acid, (meth)acryloyloxyethyl phosphate and 2-hydroxy-3-(meth)acryloyloxypropyltrimethylammonium chloride; nitrogen-containing monomer such as (meth)acrylamide, aminoethyl methacrylate and dimethylaminoethyl (meth)acrylate; polyethylene glycol (meth)acrylate. They can be used either singly or in combination.

The phosphorylcholine-analogous-group-containing polymer can be obtained by polymerizing a monomer composition, which is composed of the above-described phosphorylcholine-analogous-group-containing monomer, and optionally, another monomer mixed as needed, in accordance with a usual radical polymerization method. In general, the molecular weight of the phosphorylcholine-analogous-group-containing polymer can be, for example, in a range of from 5,000 to 5,000,000 in terms of weight average molecular weight. In the present embodiment, the phosphorylcholine-analogous-group-containing polymer is polymerized to have a molecular weight predetermined in accordance with the molecular size of biomicromolecules to be separated, as will be described subsequently herein.

The modification of the surfaces of throughpore and mesopores with the phosphorylcholine-analogous-group-containing polymer can be conducted by chemically binding the phosphorylcholine-analogous-group-containing polymer to silanol groups existing on the surface of the monolithic silica. By the modification with the phosphorylcholine-analogous-group-containing polymer, the pore size of each mesopore formed in the silica matrix is decreased by as much as the thickness of a surface-modifying film of the phosphorylcholine-analogous-group-containing polymer. The decrease in mesopore size as a result of the modification with the phosphorylcholine-analogous-group-containing polymer is dependent upon the molecular weight of the modifying polymer, and the greater the molecular weight, the smaller the mesopore size.

(3) Optimization for Biomicromolecules to be Analyzed

The separation of biomicromolecules from a biosample by the monolithic silica column is conducted by allowing only the biomicromolecules to enter the mesopores and retaining them there on the basis of the molecular sieving effect relying upon a difference in pore size between the throughpores and the mesopores. In order to efficiently retain the biomicromolecules in the mesopores at this time, it is desired to have the molecular size of the target biomicromolecules and the pore sizes of the mesopores conformed to each other so that neither biomicromolecules other than those to be separated nor proteins of larger molecular sizes would enter the mesopores.

In the present embodiment, the surfaces of mesopores formed with a size predetermined in accordance with the molecular weight of the biomicromolecules to be separated are, therefore, modified with the phosphorylcholine-analogous-group-containing polymer which has been polymerized to have a predetermined molecular weight in accordance with the molecular weight of the biomicromolecules. As a result, the pore sizes of the mesopores surface-modified with the phosphorylcholine-analogous-group-containing polymer are set to become comparable to the molecular size of the biomicromolecules to be separated. In other words, the mesopore size of the monolithic silica column and the molecular weight of the phosphorylcholine-analogous-group-containing polymer are adjusted such that the pore size obtained by subtracting the film thickness of the surface-modifying phosphorylcholine-analogous-group-containing polymer from the mesopore size conforms to the molecular size of the biomicromolecules to be separated.

Described specifically, when it is desired to separate cortisol as biomicromolecules, the mesopore size may be set, for example, at 12 nm or so, while the molecular weight of the phosphorylcholine-analogous-group-containing polymer may be set, for example, at 30,000 Da or so. Because the film thickness of the phosphorylcholine-analogous-group-containing polymer modifying the surface of each mesopore becomes several nanometers or so in this situation, the mesopore size can be determined by subtracting the film thickness (several nanometers) from the mesopore size (12 nm), that is, can be 10 nm or so. This mesopore size is comparable to the molecular size (length: 12 Å, width: 6 Å). It is, therefore, possible to allow cortisol, the molecular size of which is significantly smaller compared with the mesopore size, to enter the mesopores while preventing proteins of greater molecular sizes as impurities from entering the mesopores.

2. Separation Method of Biomicromolecules

(1) Biomicromolecules to be Separated

In the present embodiment, biomicromolecules to be separated are a neurotransmitter, hormone or the like. Examples can be catecholamines such as adrenaline and dopamine, physiologically active peptides such as oxytocin and endorphin, and hormones such as follicular hormone, lutealhormone, androgen, insulin, glucagon, gonadotropin, follicle-stimulating hormone, luteinizing hormone, growth hormone, adrenocortical hormone, thyroid hormone, parathormone, prolactin, thyrotropin, and adrenocorticotropin; and their metabolites, derivatives, intermediates and the like. In addition, biomicromolecules to be separated can also be thyrotropin (TSH), triiodothyronine (T3), psilocin (T4), chorionic gonadotropin (HCG), and human placental lactgen (HPL); and their metabolites and the like.

(2) Solution to be Separated

A solution that contains biomicromolecules to be separated can be a body fluid, its dilution or the like, although no particular limitation is imposed thereon. The term “body fluid” as used herein shall embrace all fluids that fill up vessels or between tissues or cells in the animal body as well as fluids that are released or secreted from the body to the outside, and illustrative are blood, plasma, serum, lymph, lacrimal fluid, spinal fluid, and the like. In the biomicromolecule-separating, monolithic silica column according to the present embodiment, proteins are prevented from being adsorbed on the column owing to the high hydrophilicity which the phosphorylcholine-analogous-group-containing polymer modifying the surface of the silica matrix and the surfaces of pores formed in the silica matrix possesses. As a consequence, biomicromolecules can be separated and collected with a high yield even from a solution that contains a great deal of proteins, such as a body fluid.

Instead of a body fluid or the like, the solution that contains the biomicromolecules to be separated can also be, for example, an aqueous solution, a solution containing one or more organic solvents, a mixed solution obtained by mixing an aqueous solution and one or plural organic solvents together, or the like.

(3) Separation Procedure

According to the separation method according to the present embodiment for biomicromolecules, the target biomicromolecules are separated from a solution by using the above-mentioned monolithic silica column. Described specifically, the solution that contains the biomicromolecules to be separated (hereinafter called “sample solution”) is loaded onto the monolithic silica column to have the biomicromolecules retained in mesopores. Prior to the loading of the sample solution, a buffer or water (which will be called “a running buffer”) may be pumped through the column. By once stopping the pumping of the running buffer or together with the running buffer, the sample solution is loaded onto the column.

As the monolithic column has greater throughpores compared with existing columns packed with microparticles, the sample solution can be loaded at a low pressure onto the column at this time. Moreover, in the monolithic column according to the present embodiment, hydrophilicity has been imparted to the surfaces of the throughpores and mesopores by their chemical modification with the phosphorylcholine-analogous-group-containing polymer so that, even when a sample solution with a great deal of proteins contained therein such as a body fluid or its dilution is employed, the proteins are hardly adsorbed on the monolithic silica. It is, therefore, feasible to suppress an increase in column pressure, and hence, to load the sample solution at a still lower pressure.

The feasibility of low-pressure loading has made it possible to reduce the column volume by making the column diameter smaller than the existing column diameter provided that the separation capacity is the same. Scattering and loss of biomicromolecules can, therefore, be reduced. It has also become possible to separate biomicromolecules even from a small amount of sample solution.

In the monolithic silica column according to the present embodiment, the pore sizes of the mesopores surface-modified with the phosphorylcholine-analogous-group-containing polymer have been controlled to be comparable to the molecular size of biomicromolecules to be separated. It is, therefore, possible to prevent other biomicromolecules and proteins of greater molecular weights from entering the mesopores. Only the target biomicromolecules can, therefore, be selectively allowed to enter the mesopores and be retained there.

Through the monolithic silica column onto which the sample solution has been loaded, a buffer (elution buffer) is then pumped to elute the biomicromolecules. As this elution buffer, the above-described running buffer can also be used. When the sample solution is loaded onto the column after once stopping the pumping of the running buffer, resumption of the pumping of the running buffer firstly causes elution of the proteins, followed by elution of the target biomicromolecules, owing to the molecular sieving effect. When the sample solution is loaded together with the running buffer onto the column, on the other hand, the proteins are firstly eluted, followed by elution of the target biomicromolecules. By collecting buffer fractions eluted later and containing the biomicromolecules, the biomicromolecules which have been selectively allowed to enter the mesopores and have been retained there can, therefore, be collected with a high yield.

With an existing column, the use of a running buffer containing an organic solvent was needed at this time for the elution of the proteins and biomicromolecules. Accordingly, the organic solvent was contained in the collected solution of the biomicromolecules, and in some instances, caused a problem in the subsequent analysis. When subjecting the collected solution of the biomicromolecules to affinity analysis such as ELISA, for example, the affinity to biomicromolecules such as an antibody or aptamer varies depending upon the concentration of the organic solvent in the solution of the biomicromolecules, thereby developing a potential problem of affecting the accuracy and/or reproducibility of the analysis results. With the monolithic silica column according to the present embodiment, the adsorption of proteins and biomicromolecules hardly takes place so that a buffer free of an organic solvent (or a buffer containing an organic solvent at a low concentration) can be used. As a consequence, the subsequent analysis will not be affected by an organic solvent which would otherwise be contained in the collected solution of biomicromolecules.

### EXAMPLES

### 1. Separation of Cortisol with Biomicromolecule-Separating, Monolithic Silica Column

(1) Preparation of Monolithic Silica Column

A commercially-available monolithic silica column (throughpore size: 2 μm, mesopore size: 12 nm, column size: 0.53 mm in diameter (outer diameter: 0.66 mm)×60 mm) was surface-modified with an MPC polymer (molecular weight: approx. 30,000 Da). After an MPC solution (0.03% ethanol solution) containing 90% of MPC units and 10% of 3-methacryloyloxypropyltrimethoxysilane was pumped as a surface treatment solution through the column for 120 min or longer to spread it onto the surfaces of the throughpores and mesopores, a reaction was allowed to proceed at 60° C. for 30 minutes to conduct surface treatment. After allowed to cool to room temperature, acetonitrile was pumped for several minutes through the column to wash off the unreacted surface treatment agents.

(2) Analysis by HPLC

The thus-prepared biomicromolecule-separating, monolithic silica column was connected to a UV detector to assemble an HPLC system (“SHISEIDO NANOSPACE”), and separation and detection of cortisol added to a 5% aqueous solution of saliva. Using ultrapure water as a running buffer, an aliquot (1 μL) of a 5 μM aqueous solution of cortisol in the 5% aqueous solution of saliva was subjected at a flow rate of 50 μL/min to HPLC analysis. The detection of cortisol was conducted by measuring an absorbance at a wavelength of 242 nm.

For the sake of a comparison, separation and detection of cortisol was conducted likewise from another aliquot (1 μL) of the 5 μM aqueous solution of cortisol in the 5% aqueous solution of saliva by using a commercially-available pretreatment separation column (“CAPCELL PAK MF Ph-1,” product of Shiseido Co., Ltd.; 2.0 mm I.D.×35 mm). It is to be noted that the analysis by the commercially-available column was conducted at a flow rate of 200 μL/min.

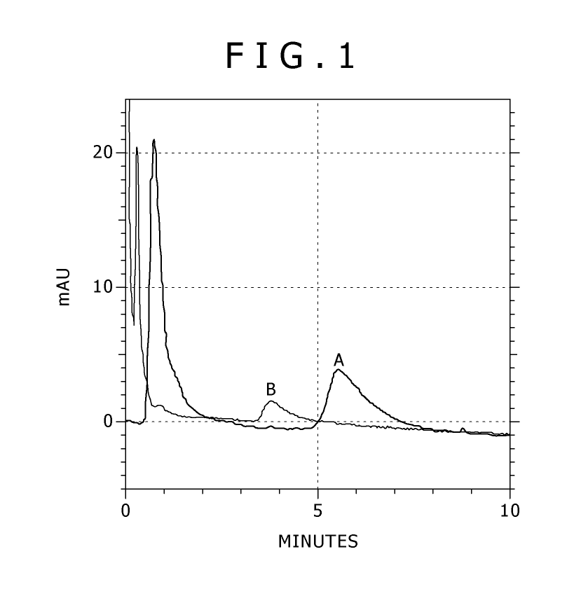

FIG. 1 shows a chromatogram obtained by the biomicromolecule-separating, monolithic silica column and the commercially-available pretreatment separation column. With the biomicromolecule-separating, monolithic silica column, a peak of cortisol (see letter A in the chromatogram) is observed around an elution time of 6 min. With the commercially-available pretreatment separation column, on the other hand, a peak (see letter B) is observed around an elution time of 4 min. As shown in the chromatogram, it is appreciated that with the biomicromolecule-separating, monolithic silica column, a higher cortisol peak was detected and cortisol was successfully separated with a higher yield than with the commercially-available pretreatment separation column.

According to the biomicromolecule-separating, monolithic silica column of the present embodiment, low-pressure loading is feasible, and moreover, a column of smaller volume can be used to permit separation of biomicromolecules at relatively high concentration even from a small amount of sample solution. Therefore, the present embodiment can be used for the high-sensitivity detection of biomicromolecules from a small amount of sample solution in the field of g-TAS such as medical diagnosis biochips making use of microchips, and can contribute to miniaturization of such devices.

According to the biomicromolecule-separating, monolithic silica column of the present embodiment, biomicromolecules can be recovered in a solution which is free of any organic solvent. Upon conducting high-sensitivity detection by a biosensor or the like in the field of g-TAS, the present embodiment can hence obviate work which would otherwise be needed for the removal of an organic solvent from a solution of biomicromolecules, thereby contributing to the facilitation of automation of an analysis system.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention claimed is as follows:

1. A biomicromolecule-separating, monolithic silica column having a silica matrix and pores formed in the silica matrix, the silica matrix and pores have been modified at surfaces thereof with a polymer, which is obtainable by polymerization of a monomer composition comprising a phosphorylcholine-analogous-group-containing monomer represented by the following formula (1): 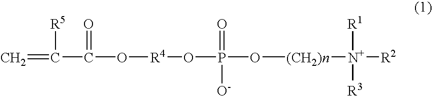
wherein R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, such that the surface-modified pores are provided with a pore size comparable to a molecular size of biomicromolecules to be separated.

2. A method for separating biomicromolecules, which comprises using a biomicromolecule-separating, monolithic silica column having a silica matrix and pores formed in the silica matrix, said silica matrix and pores having been modified at surfaces thereof with a polymer, which is obtainable by polymerization of a monomer composition including a phosphorylcholine-analogous-group-containing monomer represented by the following formula (1): 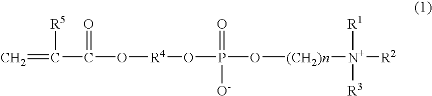
wherein R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, such that the surface-modified pores are provided with a pore size comparable to a molecular size of biomicromolecules to be separated.

3. A process for producing a biomicromolecule-separating, monolithic silica column, the process comprising:
providing a monolithic silica column having a silica matrix and pores formed in the silica matrix, said pores having a pore size predetermined in accordance with biomicromolecules to be separated,
providing a polymer obtainable by polymerization of a monomer composition, which includes a phosphorylcholine-analogous-group-containing monomer represented by the following formula (1): 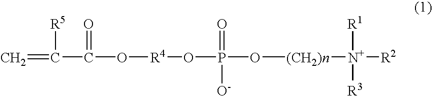
wherein R¹, R² and R³ are the same or different and each represent a hydrogen atom, C₁₋₆ alkyl group or C₁₋₆ hydroxyalkyl group, R⁴ represents a C₁₋₆ alkylene group, R⁵ represents a hydrogen atom or methyl group, and n stands for an integer of from 1 to 4, to a predetermined molecular weight in accordance with a molecular size of the biomicromolecules to be separated, and
modifying the silica matrix and pores of the monolithic silica column at surfaces thereof with the polymer.
